(19) United States
(12) Patent Application Publication
(10) Pub. No.: US 2026/0121418 A1
(43) Pub. Date: Apr. 30, 2026

(54) METHOD OF ADAPTIVELY CONTROLLING CHARGING MODULE ACCORDING TO LOAD VARIATION

(71) Applicant: AHA CO., LTD., Gyeonggi-do (KR)

(72) Inventor: GI DO GOO, Seoul (KR)

(21) Appl. No.: 19/331,077

(22) Filed: Sep. 17, 2025

(30) Foreign Application Priority Data
Oct. 28, 2024 (KR) 10-2024-0148335

(51) Int. Cl. H02J 7/04; H02M 1/42

(52) U.S. Cl. CPC H02J 7/04; H02M 1/4208; H02J 2207/20

(57) ABSTRACT

A method is for adaptively controlling a charging module that converts three-phase AC input to DC output with improved power factor correction. The method includes performing Clarke and Park transforms on input three-phase AC voltages to obtain d-q axis components, measuring and transforming boost inductor currents to obtain current axis components, generating control values through current-loop and voltage-loop modules based on target and measured values, and synthesizing PWM signals to control switching operations. The method features adaptive phase angle computation using a proportional-integral controller that responds to load variations in real-time. The control system maintains high power factor under varying load conditions by continuously adjusting the phase reference based on the q-axis voltage error. This approach minimizes power losses, reduces harmonic distortion, and ensures stable operation across the full operating range of the charging module while maintaining unity power factor.

### CROSS-REFERENCE TO RELATED APPLICATION AND CLAIM OF PRIORITY

This application claims priority under 35 U.S.C. § 119 of Korean Patent Application No. 10-2024-0148335, filed on Oct. 28, 2024, in the Korean Intellectual Property Office, the entire disclosure of which is incorporated herein by reference for all purposes.

### BACKGROUND

### 1. Field of the Invention

The present disclosure relates to a method of controlling a charging module. More specifically, it pertains to a control method for a power conversion device that converts alternating current (AC) power to direct current (DC) power, which can adaptively operate in the face of load fluctuations to provide stable current and voltage control. The invention aims to provide a new control method that can maintain the highest power factor under load fluctuations and improve system stability.

### 2. Description of the Related Art

Power conversion devices that convert AC power to DC power are widely used in various industries. However, these charging modules often suffer from a decrease in power factor during the power conversion process. In a three-phase large power converter, the power factor can be significantly reduced due to the discontinuous flow of current, which can lead to a decrease in system efficiency and power quality.

To address this issue, Power Factor Correction (PFC), a technique to improve power factor, is widely used in power conversion devices. PFC works by synchronizing the current waveform with the alternating voltage waveform to improve the power factor and reduce power losses. In particular, the active PFC method has the advantage of achieving a higher power factor through precise current control compared to the passive PFC method.

Despite its advantages, the control algorithm for active PFC is often complex and can be difficult to implement to achieve the design goal. Furthermore, when the load fluctuates, the power factor may become unstable, or the circuit may experience oscillations, which can reduce the stability of the system. A prior art document, Application No. 10-2019-0123869, discloses a “switching component mode power supply with PFC burst mode control”. Therefore, there remains a need for a PFC technology that solves these problems and can adaptively operate in the face of load fluctuations to provide stable current and voltage control.

### SUMMARY

The present invention aims to optimize the power efficiency of a system by controlling the current and voltage through a Clarke transform and a Park transform related to the input voltage of a charging module. In particular, the control device accurately analyzes the phase difference of voltage and current to derive the optimal control value and controls the switching of the charging module based on it to maintain a high-power factor.

A method of controlling a charging module, wherein the control unit controls the charging module to solve any of the foregoing problems, wherein the control unit performs a Clarke transformation based on a first three-phase alternating voltage input to the charging module to convert the three-phase alternating voltage into two two-phase Cartesian voltages, uα and uβ; wherein the control unit performs a Park transform based on the uα, the uβ, and the first phase value to convert the Cartesian coordinate system to a rotational coordinate system, resulting in computing u_{d} and u_{q} values; wherein the control unit performs a Park transform based on the second three-phase alternating voltage flowing to a boost inductor of the charging module and the first phase value to compute id and i_{q} values; wherein the control unit obtains a first control value using a first loop module based on a predetermined target value of the i_{q},i*_{q}, the i_{q} and the u_{q}; wherein the control unit obtains a second control value using a second loop module based on a voltage target value, an alternating link voltage value, the i_{q} and the u_{q}; and wherein the control unit computes a third three-phase alternating voltage based on the first control value and the second control value; converting the third three-phase alternating voltage into a PWM signal and inputting it to a switching component of the charging module to control a switching action; wherein the control unit may calculate the first phase value based on a difference between the u_{q} and a target value (u_{qref}) of the u_{q} using a proportional-integral module.

According to the present invention, the control device converts the input voltage of the charging module into a direct current component by means of a Clarke conversion and a Park conversion, and controls the current and voltage based on this, so that a high-power factor can be maintained even when the load fluctuates. In addition, by accurately analyzing the phase difference of the current and voltage, the optimal switching behavior can be implemented to minimize losses in the power conversion process and maximize the power efficiency of the system.

The control device can stably control the current and voltage underload fluctuations to maintain a high-power factor continuously, thereby improving the efficiency of the power conversion system. In addition, the stability of the system can be greatly improved by controlling the discontinuous flow of voltage and current and responding adaptively to load fluctuations through PI control. This minimizes circuit oscillations or instability.

u_{q} Power losses can be reduced by optimizing the switching frequency by controlling it based on the difference between and the target value, and the efficiency of the charging module can be maximized by precisely controlling the current flow. Furthermore, by adaptively adjusting the proportional and integral constants in real time according to load fluctuations, the power factor degradation can be prevented, and the reliability of the power conversion system can be increased.

Through these effects, the present invention can significantly improve the overall performance of a charging module system that converts alternating current power to direct current and maximize energy efficiency.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a FIG to illustrate the control unit of the present invention and parts that may be connected therewith.

FIG. 2 is a FIG illustrating a charging module referred to in the present invention.

FIG. 3 is a block diagram illustrating how the control unit regulates an output voltage caused by an external factor, according to one embodiment of the present invention.

FIG. 4 is a block diagram illustrating a PI method that can be applied to a first transfer function and a second transfer function, according to one embodiment of the present invention.

FIG. 5 is a block diagram illustrating a method for downstream processing, in accordance with one embodiment of the present invention.

FIG. 6 is a flowchart depicting a step-by-step process illustrating a procedure for a proportional-integral (PI) control algorithm, according to one embodiment of the present invention.

FIG. 7 is a block diagram illustrating a control algorithm for how a control unit controls a charging module, in accordance with one embodiment of the present invention.

### DETAILED DESCRIPTION

Various embodiments will be described with reference to the drawings. In the present invention, various descriptions are presented to provide an understanding of the invention. However, it is apparent that these embodiments may be practiced without these specific descriptions.

The term “or” is intended to mean an implied “or” rather than an exclusive “or,” i.e., where not otherwise specified or apparent from the context, “X utilizes either A or B” is intended to mean one of the natural implied substitutions, i.e., where X utilizes A; X utilizes B; or X utilizes both A and B, “X utilizes either A or B” may apply in any of these cases. Further, the term “and/or” as used in the present invention is to be understood to refer to and include all possible combinations of one or more of the enumerated related items.

Further, the terms “including” and/or “comprising” should be understood to mean that the feature and/or component is present. However, the terms “including” and/or “comprising” shall not be understood to exclude the presence or addition of one or more other features, components, and/or groups thereof. Further, unless otherwise specified or unless it is clear from the context that the singular form is intended, the singular in the present invention and claims should be interpreted to mean “one or more” generally.

And the term “at least one of A or B” should be construed to mean “comprising A alone,” “comprising B alone,” “comprising a combination of A and B,” and so on.

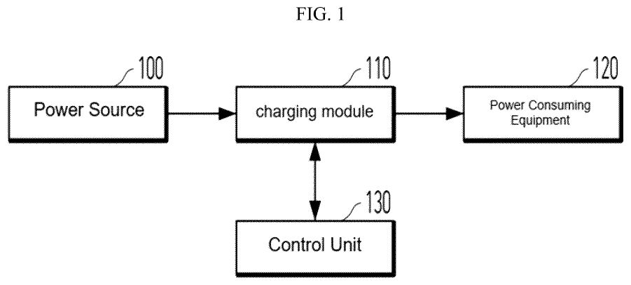

FIG. 1 is a FIG to illustrate parts that may be associated with the control unit of the present invention.

The power source 100 that can be input to the charging module 110 of the present invention is a three-phase AC power source, which can be used as an input to the charging module 110, converted to direct current power, and delivered to power-consuming equipment 120.

For example, if the three-phase AC power source in the factory is 380 volts, this voltage may be input to the charging module 110, converted to direct current 600 volts, and supplied to the electric motor or battery system that is the power-consuming equipment 120.

In this case, the charging module 110 may suffer from a power factor reduction during the power conversion process. In a high-power three-phase AC converter, the power factor may be significantly reduced due to discontinuous flow of current, which may result in reduced system efficiency and poor power quality.

Accordingly, in accordance with embodiments of the present disclosure, the charging module 110 may be adjusted by the control unit 130 of the present disclosure to increase the power factor. Further embodiments of this will be described later.

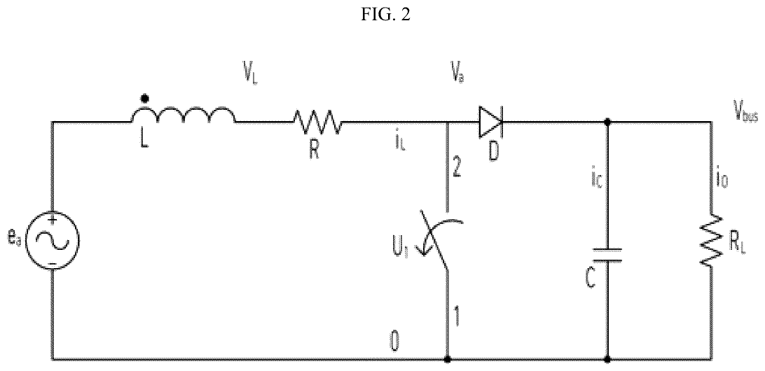

FIG. 2 is a FIG to illustrate the charging module 110 referred to in the present invention.

Prior to description, the components of FIG. 2 will first be described.

AC power source (ea): The AC power source on the far left (ea) shows a three-phase AC power source, which is used as the input to the charging module. Inductor (L): The inductor plays an important role in smoothing the input AC voltage and allowing the charging module to step up the output DC voltage. The inductor absorbs fluctuations in current and minimizes power losses during the conversion process, increasing the system efficiency. Internal resistance (R): Internal resistance is an element of resistance to current flow, which helps control the flow of current in a system to ensure stable operation. In particular, internal resistors control current flow and protect the system from load fluctuations. Switching component (U1): The switching component is the core element of the charging module, which amplifies the output voltage by disconnecting and connecting the input current through switching action. In this invention, the switching signal is generated in a PWM manner, and the control device analyzes the current and voltage to control the switching component at the optimal timing. Diode (D): Diodes are responsible for blocking reverse current, preventing energy from flowing in the opposite direction. In charging modules, they help transfer energy stored in the inductor to the output stage when the switching components are off. Capacitor (C): Capacitors play an important role in smoothing the output voltage. It reduces the ripple voltage caused by the AC to DC conversion process and helps to output a constant DC voltage. Load resistor (R_{L}): The load resistor (R_{L}) is what the charging module supplies DC voltage to. The current and voltage vary depending on this load, and the control unit of the present invention adapts in real time to the load fluctuations to ensure stable current and voltage supply.

Also, the inductor voltage (V_{L}): V_{L} represents the voltage across the inductor (L). Since an inductor is a device, whose voltage is induced by the rate of change of current, the value of VL changes when the current flowing through the inductor changes rapidly. The inductor voltage changes as the switching component is turned on or off, and acts to store and release energy. Inductor current (i_{L}): iLis the current flowing through the inductor. The current flowing through an inductor depends on the characteristics of the input voltage and the load and plays an important role in increasing the output voltage of the charging module. The inductor current increases or decreases depending on the switching action. Capacitor current (i_{C}): i_{C} represents the current flowing in the capacitor (C). The capacitor acts to smooth out the DC voltage, and the capacitor current (iC) is the current that occurs when the capacitor is charged or discharged. Load current (i_{O}): i_{O} is the output current flowing through a load resistor (R_{L}). This current is a direct current delivered from the output of the charging module to the load, and the value of i_{O} varies depending on the characteristics of the load. When the load changes, i_{O} also changes, and the system of the present invention detects it and controls it adaptively according to the load change. Output voltage (V_{bus}): Vbus refers to a direct current voltage generated at the output of the charging module 110. After the input alternating current voltage is converted to direct current, a stabilized direct current voltage with ripple removed by a capacitor appears as V_{bus}. V_{bus} is the voltage supplied to the load, which is the main output signal of the charging module.

In this circuit configuration, the charging module 110 of the present invention aims to precisely manage the input three-phase AC (Alternating Current) power through a control unit to maintain a stable high-power factor despite load fluctuations.

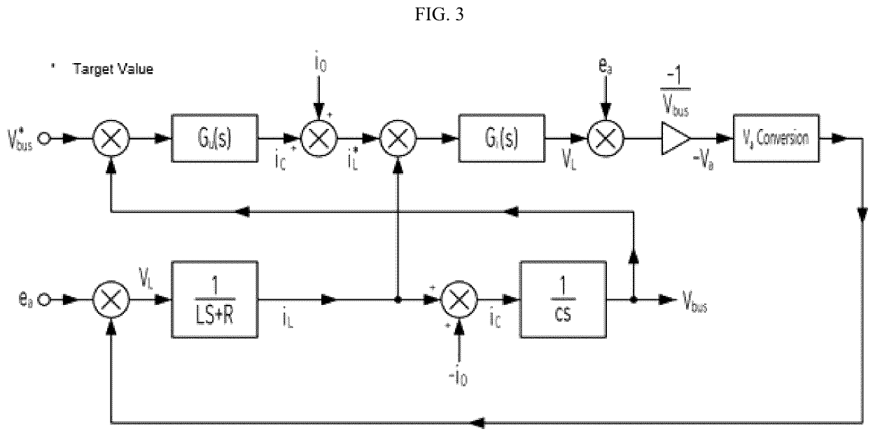

FIG. 3 is a block diagram illustrating how the control unit regulates the output voltage due to external factors, according to one embodiment of the present invention.

Before proceeding with the description, the components of FIG. 3 will be described.

Target Voltage (V*_{bus}): The target value of the output voltage, which indicates the output voltage that the control should achieve. This value is compared to the output voltage (V_{bus}) and used to generate the control signal. First transfer function and second transfer function Gᵤ(S) and Gᵢ(S): Gᵤ(S) is a transfer function based on the capacitor current (i_{C}), which generates a control signal to regulate the variation of the output voltage. Gᵢ(S) is a transfer function based on the inductor current (i_{L}), which performs feedback control on the current flowing in the inductor to regulate the fluctuation of the current: Va Conversion is a process to regulate the transferred voltage signal, and after conversion, Va is used as a feedback signal. −Va means the opposite signal.

Previously, the structure of the charging module 110 was described with reference to FIG. 2. At this time, the inductor current (i_{L}), output voltage (V_{bus}), and capacitor current (i_{C}) of the charging module can be expressed as follows.

$${i}_{L} = \frac{{V}_{L}}{{Z}_{L}} = \frac{{V}_{L}}{j ω L + R} ⇒ {i}_{L} = \frac{1}{LS + R} {V}_{L} \qquad [ Equation 1 ]$$

$${V}_{BUS} = \frac{1}{C} \int {i}_{C} dt ⇒ {V}_{BUS} = \frac{1}{CS} {i}_{C}$$

$${i}_{C} = {i}_{L} - {i}_{O}$$

Furthermore, the transfer functions Gᵤ(S) and G₁(S) can be defined as follows.

$${G}_{i} ( S ) = \frac{{K}_{pi} ( s + {K}_{ii} )}{s} , {G}_{i} ( S ) = \frac{{K}_{pi} ( s + {K}_{ii} )}{s} , \qquad [ Equation 2 ]$$

Referring to FIG. 3, the control device of the present invention receives input voltage (alternating current power) (ea), target voltage (V*_{bus}), and load current (i_{O}), and generates output voltage (V_{bus}) and inductor voltage (V_{L}) as output signals based on these in order to realize adaptive control according to load fluctuations. Between the above input and output, the control unit can process the input signal through a transfer function and a feedback loop to maintain a stable output voltage.

Specifically, the control unit may compute an inductor voltage (V_{L}) to obtain a predetermined target voltage (V*_{bus}) (S100); →calculate a current voltage error by obtaining a difference between the target voltage (V*_{bus}) and an output voltage (V_{bus}) (S110); →pass the current voltage error to a first transfer function Gᵤ(s) to output a capacitor current i_{C} (S120); →determining a target inductor current (i*_{L}) by finding the difference between the capacitor current (i_{C}) and the load current (i_{O}) (S130); →calculating a current error by finding the difference between the target inductor current (i*_{L}) and the inductor current (i_{L}) (S140); →passing the current error to a second transfer function Gᵢ(S) to output an inductor voltage (V_{L}) (S150).

The inductor voltage (VL) may be converted into a feedback signal for adjusting the output voltage (Vbus). Specifically, the control unit may generate a feedback signal (−Va or Va) by multiplying the inductor voltage (vL) with an alternating current power source (ea) and scaling based on ‘−1/output voltage’ (−1/V_{bus}).

Then, to calculate an output voltage (V_{bus}), the control unit outputs an inductor voltage (V_{L}) by finding the difference between the alternating current power (ea) and the feedback signal (S200); →calculating an inductor current (iL), which is the current flowing in the inductor according to the inductor voltage (V_{L}) (S210); →calculating a capacitor current (iC) by finding the difference between the inductor current (iL) and the load current (iO) (S220); →calculating the output voltage (Vbus) based on the capacitor current (iC) (S230). In other words, the control device may perform steps S100 to S150 and steps S200 to S230 in a feedback relationship with each other and may implement an adaptive control algorithm in response to load fluctuations.

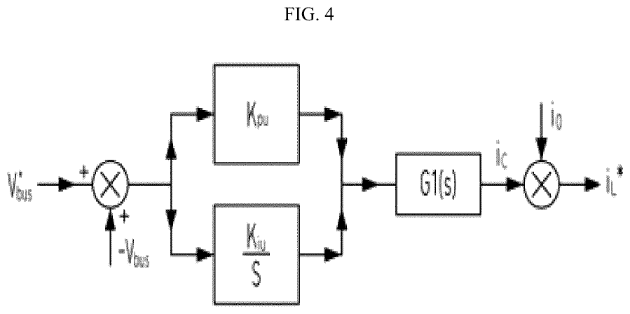

FIG. 4 is a block diagram illustrating a PI method that can be applied to a first transfer function and a second transfer function, according to one embodiment of the present invention.

iL Referring to FIG. 4, in one embodiment of the first transfer function (Gu(S)) and the second transfer function (Gi(S)) of the present invention, the first transfer function (Gu(S)) may reprocess the target inductor current (i_{L}) downstream to change the inductor current (i_{L}), which is the current flowing in the inductor, based on the fact that the target inductor current (i*_{L}) changes as the load current (i*_{L}) changes.

With further reference to FIG. 4, the present invention can control the inductor current (i_{L}) because the target inductor current (i*_{L}) changes as the load current (i_{O}) changes. To ensure adaptive behavior in response to load fluctuations, the control algorithm may be configured to process the target inductor current (i*_{L}) at a later stage to vary the actual inductor current. As a further example, the control may detect a difference between the inductor current (i_{L}) flowing in the inductor and the load current (i_{O}) and act adaptively in the current control loop based on this. For this purpose, PI control is used, which is designed to react instantaneously to changes in the current load, and a control signal can be generated through a control block containing the constants Kpu and Kiu. This signal is processed by a third-order transfer function (G1(S)) to finally adjust the inductor current (i_{L}), minimizing the error between the target inductor current (i*_{L}) and the actual inductor current (i_{L}) while maintaining the stability of the system as the load fluctuates.

Note that “downstream” refers to the final output or application of the control signal, which serves to change the behavior of the controlled object (e.g., the charging module 110). In FIG. 4, the expression downstream processing refers to the final stage where the inductor current (iL is controlled in response to the load current (iO. Specifically, a target inductor current (i*_{L}) is set based on the variation of the load current (i_{O}), and a control signal is generated based on the difference between this target value and the actual inductor current (i_{L}). This signal is then processed through a third transfer function (G1(S)) or the like, and the latter step is to adjust the current flowing through the inductor by controlling the switching behavior of the charging module.

As a result, the control unit can appropriately control the inductor current (i_{L}) despite load fluctuations, which can improve the efficiency and power quality of the charging module 110.

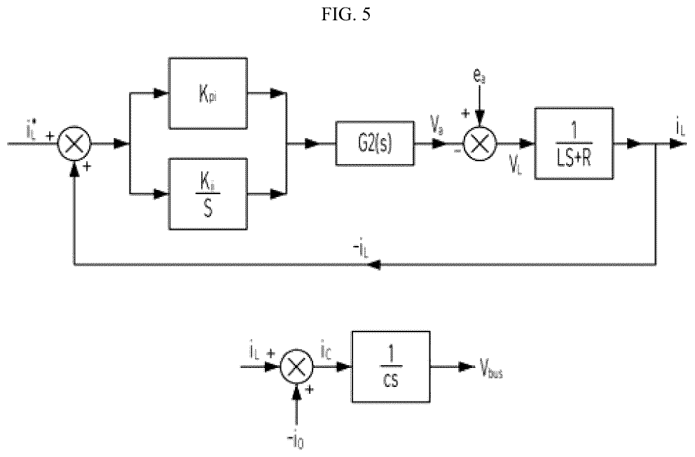

FIG. 5 is a block diagram illustrating a method for downstream processing, in accordance with one embodiment of the present disclosure.

Targeting FIG. 5, the control unit may control the inductor current (i_{L}) flowing in the inductor by a fourth transfer function (1/(LS+R)). This output can be used to output an output voltage (V_{bus}) by a fifth transfer function (1/CS) at a later stage.

The fourth transfer function (1/(LS+R)) and the fifth transfer function (1/CS) are described further below. The control device may control the inductor current (i_{L}) flowing in the inductor by the fourth transfer function (1/(LS+R)). The fourth transfer function determines the current response of the inductor and can define how the inductor current (i_{L}) varies. This transfer function is given by the following equation, where L is the inductance, R is the internal resistance connected in series with the inductor, and S is a frequency variable in the complex domain representing the time derivative of the Laplace transform. This transfer function allows the effect of internal resistance on the circuit to be reflected in the process of the inductor storing and releasing energy and allows the response speed of the inductor current to be controlled. The fourth transfer function (1/(LS+R)) determines how quickly the inductor current changes in response to input changes or load fluctuations in the system.

The fifth transfer function (1/CS) may be used to control the output voltage (V_{bus}). The fifth transfer function (1/CS) describes the capacitor voltage (V_{C}) response, where the capacitor can act to smooth the voltage and prevent sudden fluctuations. Where C represents the capacitance of the capacitor and S is a frequency variable in the complex domain. Capacitors can store and release power in response to load fluctuations or changes in input voltage, which allows them to maintain a constant output voltage. The rate of charge and discharge of the capacitor plays an important role in the stability of the output voltage and can improve the overall power quality of the control.

In conclusion, the fourth transfer function (1/(LS+R)) controls the response of the inductor current (i_{L}), and the fifth transfer function (1/CS) plays an important role in stabilizing the output voltage. This allows the charging module system to stably control the current and voltage despite load fluctuations and improves power efficiency and quality.

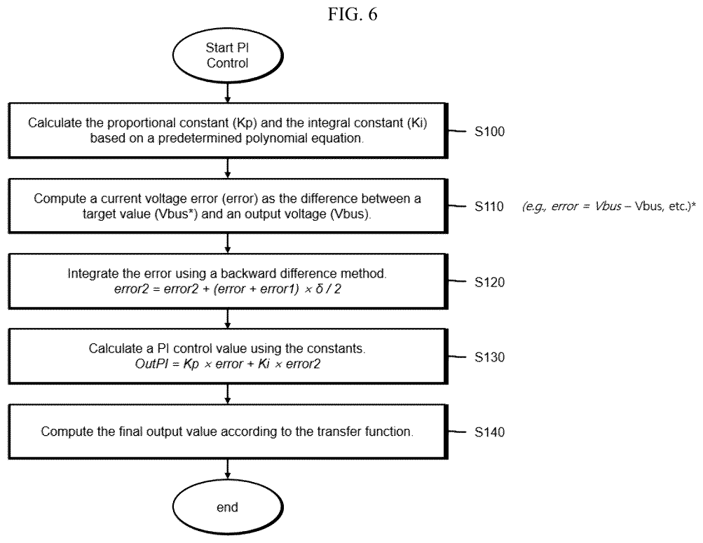

FIG. 6 is a flowchart illustrating a step-by-step process describing the procedure of a proportional-integral (PI) control algorithm, according to one embodiment of the present invention.

Earlier, it was mentioned that PI control is performed with respect to the first transfer function (Gu(S)) and the second transfer function (Gi(S)). One embodiment of this will be described with the help of a flowchart.

First, in connection with the startup phase, the control unit is activated and the variables for control are initialized. At this stage, preparation for PI control is completed and basic settings are made for the subsequent steps. For example, the charging module 110 is started, the necessary control variables are initialized, and the control algorithm is ready for execution.

In step S300, the control unit may calculate the values of the constants Kp and Ki by a polynomial equation determined in advance for each power-consuming facility 120.

These constants are needed to optimize the performance of the control unit, with Kp serving as an immediate error response and Ki serving to compensate for accumulated errors.

For example, the constant values Kp=0.5 and Ki=0.1 can be established from experimental results or mathematical analysis. These constants are adapted to the behavioral characteristics of the system.

In step S310, the control unit calculates the difference between the target voltage (V*bus) and the voltage output (V_{bus}) voltage to obtain a current voltage error, where the voltage error represents an amount of voltage that needs to be corrected by the control.

For example, if the target voltage (V*_{bus})=is 400V and the actual output voltage (V_{bus})=is 380V, the error can be calculated to be 20V This error value is then used as an important feedback variable in the control algorithm.

In step S320, the controller may calculate an integral value using a backward difference method. This method utilizes the previous error and the current error to calculate a new integral voltage error, error2.

For example, if the previous voltage error (error1)=is 15 V and the current voltage error (error) is 20 V, the integral voltage error (error2) can be calculated by the backward difference method as error2=error2+(error+error1)×δ/2, resulting in an integral voltage error of 17.5 when δ=1, or 8.75 when δ is 0.5. However, this is just an example and many other values can be applied.

In step S330, the control unit calculates the PI control signal using the constant values. The proportional constant (Kp) and the integral constant (Ki) are multiplied by the current voltage error and the integral voltage error, respectively, to produce a final PI control signal.

For example, if δ(delta) is set to 1, Kp=0.5, and Ki=0.1, the PI control signal is calculated as OutPI=K*p error+K*i error 1. Specifically, the PI control output can be calculated as OutPI=0.5×20+0.1×53=15.3

Finally, the PI control signal can be applied to the transfer function to get the final output. For example, the final output may be calculated via the transfer function G(S)=1/(LS+R), and this value may be used to adjust the inductor current or output voltage.

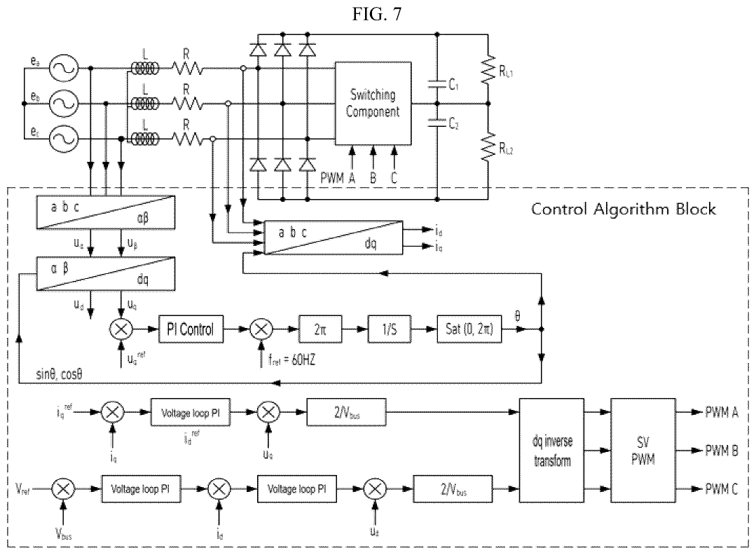

FIG. 7 is a block diagram illustrating a control algorithm for how the controller controls the charging module 110, in accordance with one embodiment of the present disclosure.

Referring to FIG. 7, it will be described how the control unit of the present invention controls the charging module 110.

First, the three-phase AC input voltages, and ea, eb, ec, are input as shown at the top left of the FIG, and a Clarke transformation can be performed based on them. Through this transformation, the three-phase AC signals are converted into two-phase quadrature signals, uα, uβ, which are then subjected to a Park transform to obtain the values ud, uq. As described in claim 1, the Clarke transform, and the Park transform may be performed successively to calculate the values ud and uq.

The control unit may calculate id and iq based on the inductor current (i_{L}) flowing in the boost inductor of the charging module. The iq value can then be compared to a preset target value of i*_{q} to generate a control value in the first loop module. The “current loop PI” block in the Figure fulfills this role, and the values iq and Uq can be used to generate a current control signal.

The controller can also perform voltage loop PI control by comparing the voltage target value V*_{bus} to the actual output voltage (V_{bus}. The “voltage loop PI” block at the bottom of the diagram handles this voltage control process, which results in a voltage control value. This value is in turn combined with the current control value to generate a final control signal, which can then be used to control the switching components of the charging module 110.

The PWM A, PWM B, and PWM C signals are each generated by the SVPWM signal generation block and can be passed to the switching components of the charging module to perform switching actions. As described above, it is shown that the control value can be converted into a PWM signal to control the switching component.

At this time, the first loop module may obtain a value of 1-1 by obtaining the difference between the target value of iq and the target value of iq (i*_{q}), input the value of 1-1 to the current loop PI module to obtain a value of 1-2, calculate the sum of the value of 1-2 and the value of uq to obtain a value of 1-3, and calculate the product of the value of 1-3 and 2/output voltage (V_{bus}) to obtain a voltage control value.

The current loop PI module may refer to a proportional-integral (PI) controller that performs current control. This allows the control system to implement a control strategy that minimizes the error between the target current and the actual current. Specifically, a PI controller takes as input the difference between the target value and the measured value and performs proportional and integral operations based on this error to generate a control signal. The proportional term can provide an instantaneous response by generating a value proportional to the error value, while the integral term can serve to eliminate residual error in the system by calculating the cumulative value of the error over time. By combining these two operations, the current loop PI module can generate a control signal that minimizes the error between the target current (i_{qref}) and the actual current (iq), thereby ensuring stable operation of the system.

Further, the second loop module obtains a value of 2-1 by finding the difference between the target voltage (V*_{bus}) and the output voltage (V_{bus}, and inputs the value of 2-1 to the voltage loop PI module to obtain a value of 2-2, and calculates the product of the value of 2-2 and the value of id to obtain a value of 2-3, inputting the value 2-3 to the current loop PI module to obtain a value 2-4, multiplying the value 2-4 and the value (Ud to obtain a value 2-5, and calculating the product of the value of 2-5 and 2/V_{bus} to obtain a current control value.

The proportional-integral module obtains a value of 3-1 by obtaining the difference between the target values of uq and uq (u_{qref}), inputs the value of 3-1, the proportionality constant, and the integration constant into the PI control module to obtain a value of 3-2, and operates the product of the value of 3-2 and the reference frequency to obtain a value of 3-3,
the product of the above value of 3-3 and 2π is calculated to obtain the value of 3-4, and the above value of 3-4 is integrated (1/S) to obtain the value of 3-5 which is the phase angle over time, and the remainder of the above value of 3-5 divided by 271 can be determined as the first phase value.

Further, the control device obtains a proportional constant and an integral constant calculated based on experimental data, calculates a difference between the target voltage and the output voltage to obtain a current voltage error, obtains an integral voltage error using the current voltage error and the voltage error at a previous point in time to obtain an integral voltage error, and multiplies each of the proportional constant (Kp) and the integral constant (Ki) by the current voltage error and the integral voltage error to obtain a final PI control signal,

The PI control signal can be reflected in the transfer function.

Explaining the control method of the charging module 110 as an example, first, the three-phase AC input voltages ea, eb, and ec are input. These signals are subjected to a Clarke conversion by the control system, which converts the three-phase AC signals into two-phase quadrature signals and uα, uβ. These signals can then be converted to the values ud and uq by means of a Park transform.

The control unit can calculate the values id and iq based on the inductor current (i_{L}) flowing in the boost inductor of the charging module. For example, if i_{L}=5 A, the park transformation may yield values such as id=4 A and i_{q}=1 A. The i_{q} value is then compared to the target value i*q, and the difference is used to generate a control value in the first loop module. In this process, the control system can keep the current and voltage stable.

In addition, the control unit can perform voltage loop PI control by comparing the voltage target value V*_{bus} with the actual output voltage (V_{bus}. For example, if the target voltage (v*_{bus}=400 V and the actual output voltage (V_{bus}=is 380 V, the control system can detect the difference between the two voltages and calculate a voltage control value, based on which the output voltage can be adjusted to be closer to 400 V. This value can be combined with the current control value. This value can be combined with the current control value to generate a final control signal, which can then control the switching behavior of the charging module 110.

PWM A, PWM B, and PWM C signals are generated in the SVPWM signal generation block and delivered to the switching components of the charging module. For example, the generated PWM signals can control the operation of the charging module by periodically turning on/off each switching component, thereby keeping the output voltage and current stable.

In the first loop module, the control value is generated by calculating the difference between i_{q} and the target value. For example, when i_{q}=1 A and i*_{q}=1.5 A, the control system calculates the difference between these two values and passes it to the first loop module to calculate the current control signal. In this process, the output voltage and current can be optimized to control the charging module.

The second loop module can calculate the difference between the target voltage (V*bus and the output voltage (V_{bus} and generate a control value based on it. For example, if the target voltage is 400V and the actual output voltage is 380V, the second loop module may generate a voltage control signal based on the difference, which is combined with the first loop module to produce a final control signal.

The proportional-integral module can generate the control signal using uq and its target value u_{qref}. For example, the control signal can be generated by finding the difference between uq and u_{qref}, and then the operation of the charging module can be controlled based on the control signal. In this process, the final phase value is calculated in combination with the reference frequency, which is used for accurate control.

Finally, the control unit obtains the proportionality constant, and the integral constant based on the experimental data, and calculates the difference between the target voltage and the output voltage to obtain the error. For example, if the error between the target voltage and the actual voltage is 20 V, the backward difference method can be used to compensate for this error, and then the proportional and integral constants can be used to calculate the final control signal. This allows the output voltage and current to be optimized to maximize the efficiency of the charging module.

Further, referring to FIG. 7, an embodiment of a control method utilizing DQ conversion of voltage and current can be summarized as follows.

After setting a target output voltage (V*_{bus}) and a target current (i*_{L}, i*_{C}), the voltage and current values that fluctuate due to load changes can be detected in real time and control signals can be generated accordingly. These control signals are used as inputs to determine the duty ratio of the switching circuit, which is then used to generate a PWM signal to drive the switching circuit using the SVPWM technique.

Here, the properties of the DQ transform for voltage and current can be utilized as follows. For example, apparent power (Pa) can be defined as active power (P)+reactive power (Pr). If we express voltage and current using the values of D and Q obtained from the DQ conversion, it is as shown in [Equation 3] below.

$$u = {u}_{d} + {ju}_{q} , i = {i}_{d} + {ji}_{q} . \qquad [ Equation 3 ]$$

Using this equation to find the apparent power (Pa), it becomes Specifically,
[Equation 3] represents the voltage and current expressed through the DQ transformation, where each component is the result of converting the three-phase voltage and current of the power system into a rotating coordinate system. This allows us to distinguish between the direct (d-axis) and quadrature (q-axis) components of voltage and current, and allows the control system to handle each component independently.

First, u_{d} is the d-axis voltage component, which represents the direct component in the dq conversion. This corresponds to the real component of the voltage in a power system, which corresponds to the real axis of the voltage in a rotating coordinate system. On the other hand, uq is the q-axis voltage component, which represents the quadrature component in the dq conversion, which corresponds to the imaginary component of the voltage. This corresponds to the imaginary axis of the voltage in a rotating coordinate system.

Current is similarly divided into id and i_{q}. id is the d-axis current component, which corresponds to the real component of the current in the dq transform, which represents the direct current component of the current. i_{q} is the Q-axis current component, which represents the imaginary component of the current in the dq conversion, which can be viewed as the quadrature component of the current. By separating the d- and q-axis components in this way, the current state in the power system can be analyzed and controlled more clearly.

‘j’ is a complex number unit, defined as j=−1. This mathematically indicates that the d- and q-axis components of voltage and current are in an orthogonal relationship to each other. DQ conversion utilizes this orthogonal relationship to better control the three-phase voltage and current in a power system.

The active and reactive power can be obtained using [Equation 4] below.

$${P}_{a} = u \times {i}^{*} = ( {u}_{d} + {ju}_{q} ) \times ( {i}_{d} - {ji}_{q} ) = {u}_{d} {i}_{d} + {u}_{q} {i}_{q} + j ( {u}_{q} {i}_{d} - {u}_{d} {i}_{q} ) \qquad [ Equation 4 ]$$

[Equation 4] is meant to represent the apparent power (Pa), where each component shows the power calculation utilizing the DQ converted voltage and current. By solving the equation, it can be divided into active and reactive power.

The complex number i* is the pair complex number of the current, which is used in the calculation by changing the sign of the imaginary component iq in the current. This is the process used in power calculations to distinguish real power (active power) from reactive power through the product of voltage and current.

Interpreting the result of the expression, ‘u_{d}·i_{d}+u_{q}·i_{q}’ represents active power (P), which is the power delivered to the load. This part comes from the d- and q-axis components of the voltage being multiplied by the d- and q-axis components of the current, respectively.

On the other hand, j(u_{q}·i_{d}−u_{d}·i_{q})′ represents reactive power (Pr). Reactive power is the power generated by the phase difference between voltage and current in a power system without any real energy transfer and is an important factor in determining the power factor of the system. This reactive power component is mainly caused by the interaction between the q-axis component of the voltage and the d-axis component of the current, or between the d-axis component of the voltage and the q-axis component of the current.

Through this equation, the DQ transformed voltage, and current can be utilized to obtain the apparent power (Pa), which can be separated into active and reactive power to analyze and control the efficiency of the power system.

In other words, the dq transform is used to obtain the d- and q-axis components of the voltage and current, which can then be used to calculate the apparent power (Pa). The calculated apparent power (Pa) is separated into active and reactive power, which is used to calculate the power factor in real time. As a result, control methods can be implemented to improve power factor correction (PFC) to minimize power losses and increase the efficiency of the power system.

The reason for using the above embodiment is to detect the state of voltage and current in a power system in real time due to load fluctuations, and to generate control signals accordingly to optimize the operation of switching circuits. In particular, the voltage and current of the three phases can be analyzed more simply through DQ conversion, and the active and reactive power can be separated by calculating the apparent power based on it. The main purpose of this is to calculate the power factor of the power in real time and improve the power factor to reduce power losses and improve the efficiency of the system.

This control method has the advantage of being able to adaptively control the charging module. The voltage and status of the charging module can be monitored in real time, and the voltage and current can be adaptively regulated to meet the fluctuating load through DQ conversion. Thereby, the effect of enabling the charging system to operate stably under various conditions, improving battery charging efficiency, and preventing overcharging or undercharging can be achieved.

What is claimed is:

1. A method of controlling a charging module configured to convert a three-phase alternating current (AC) input to a direct-current (DC) output, the method comprising:
receiving, at a control unit, a first three-phase AC voltage (eₐ, e_{b}, e_{c}) input to the charging module;
performing, by the control unit, a Clarke transform on the first three-phase AC voltage to obtain two orthogonal components u_{α} and u_{β};
computing, by the control unit, a first phase value;
performing, by the control unit and based on the u_{α}, the u_{β}, and the first phase value, a Park transform to obtain voltage-axis components u_{d} and u_{q};
measuring, at the control unit, a second three-phase AC current (iₐ, i_{b}, i_{c}) flowing through a boost inductor of the charging module and performing, based on the second three-phase AC current and the first phase value, a Park transform to obtain current-axis components id and i_{q};
generating, by a first current-loop module of the control unit, a first control value based on a predetermined target current value i*_{q}, the measured current component i_{q}, and the voltage component u_{q};
generating, by a second voltage-loop module of the control unit, a second control value based on a target DC bus voltage V*bus, a measured DC bus voltage V_{bus}, the current component id, and the voltage component u_{d};
computing, by the control unit, a third control value based on the first control value and the second control value;
converting the third control value into a pulse-width-modulated (PWM) signal; and
applying, by the control unit, the PWM signal to a switching component of the charging module to control a switching operation;
wherein the control unit adaptively responds to load variations by computing the first phase value using a proportional-integral (PI) module based on a difference between the component u_{q} and a target value u_{qref} of the component u_{q}, and
wherein generating the first control value by the first current-loop module comprises:
computing a first difference value (a value of 1-1) as a difference between the component i_{q} and the target current value i*_{q};
inputting the first difference value (the value of 1-1) to a current-loop PI controller to obtain an intermediate value (a value of 1-2);
computing a combined value (a value of 1-3) as a function of the intermediate value (the value of 1-2) and the component u_{q}; and
deriving the first control value, which is a voltage control value, by multiplying the combined value (the value of 1-3) by 2/V_{bus}, where V_{bus} is a measured DC bus voltage.

2. The method of claim 1, wherein the generating of the second control value by the second voltage-loop module comprises:
computing a second difference value (a value of 2-1) as a difference between the target DC bus voltage V*_{bus} and the measured DC bus voltage V_{bus} and inputting the second difference value (the value of 2-1) to a voltage-loop PI controller to obtain a voltage-loop output (a value of 2-2);
computing a third difference value (a value of 2-3) as a function of the voltage-loop output (the value of 2-2) and the component id to obtain a current-reference value;
inputting the current-reference value (the value of 2-3) to the current-loop PI controller to obtain a current-loop output (a value of 2-4);
computing a fourth difference value (a value of 2-5) as a function of the current-loop output (the value of 2-4) and the component u_{d} to obtain a modulation value; and
deriving the second control value, which is a current control value, by multiplying the modulation value (the value of 2-5) by 2/V_{bus}.

3. The method of claim 1, wherein the computing of the first phase value using the proportional-integral module comprises:
computing an error value (a value of 3-1) as a difference between the target value u_{q}ref and the component u_{q};
inputting the error value (the value of 3-1), a proportional gain, and an integral gain to a PI control block to obtain a PI output (a value of 3-2);
multiplying the PI output (the value of 3-2) by a reference electrical frequency to obtain an angular frequency value (a value of 3-3);
multiplying the angular frequency value (the value of 3-3) by 271 to obtain an angular rate value (a value of 3-4);
integrating the angular rate value (the value of 3-4) over time to obtain a phase angle (a value of 3-5); and
determining the first phase value as a remainder of the phase angle (the value of 3-5) modulo 2π.

4. The method of claim 1, further comprising:
determining a proportional gain Kₚ and an integral gain Kᵢ based on predetermined experimental data;
computing a present voltage error as a difference between the target DC bus voltage V*_{bus} and the measured DC bus voltage V_{bus};
computing an integral voltage error using a backward-difference method based on the present voltage error and a prior voltage error;
computing a final PI control signal as Kₚ multiplied by the present voltage error plus Ki multiplied by the integral voltage error;
applying the final PI control signal to a plant model including a transfer function 1/(L·S+R) to control an inductor current i_{L} of the charging module and a transfer function 1/(C·S) to smooth the DC bus voltage V_{bus}; and
driving the switching component based on the resulting control to regulate the switching operation.
